(19) United States
(12) Patent Application Publication
(10) Pub. No.: US 2024/0421583 A1
(43) Pub. Date: Dec. 19, 2024

(54) LEAKAGE CURRENT PROTECTION DEVICE INTEGRATING LOAD-END FUNCTIONS

(71) Applicant: Chengli LI, Suzhou (CN)

(72) Inventors: Chengli LI, Suzhou (CN); Xiaoming ZHANG, Suzhou (CN); Long CHEN, Suzhou (CN)

(73) Assignee: Chengli LI, Suzhou (CN)

(21) Appl. No.: 18/350,817

(22) Filed: Jul. 12, 2023

(30) Foreign Application Priority Data
Jun. 16, 2023 (CN) 202310715960.5
Jun. 16, 2023 (CN) 202321540120.1

(51) Int. Cl. H02H 3/04; H02H 1/00

(52) U.S. Cl. CPC H02H 3/044; H02H 1/0007

(57) ABSTRACT

A leakage current protection device includes a shell and a core assembly disposed within the shell, the core assembly including a leakage current protection assembly coupled to power supply lines, the leakage current protection assembly including an execution unit and an operation unit configured to control the execution unit, the execution unit being operable to connect and disconnect an electrical connection between the input end and the output end of the power supply lines, and a auxiliary function assembly, coupled to the leakage current protection assembly, configured to perform at least one load-end function. By integrating the auxiliary function assembly into the leakage current protection device, the device can perform at least a part of the load-end function, such as power conversion function and/or electromagnetic compatibility filter function. The device is reliable and versatile, suitable for various electrical appliances. It also has a simple structure and wide applicability.

### BACKGROUND OF THE INVENTION

This invention relates to leakage current protection devices, and in particular, it relates to a leakage current protection device with auxiliary functions.

With technological advancements and the increased awareness for electrical safety, electrical products having appliance leakage current interruption (ALCI) functions are gaining wide applications, and more and more types of appliances are equipped with such devices.

### SUMMARY OF THE INVENTION

With the increased demand for reliability and functionality of leakage current protection devices, there is a need for such devices that can integrate some functions of the appliance (the electrical load) into the device. To meet such needs, embodiments of the present invention provides a leakage current protection device which integrates certain functions that are traditionally provided in the appliance at the load end of the electrical plug, in particular, AC/DC conversion function and/or electromagnetic compatibility (EMC) filter function, to meet the requirements of various applications.

Accordingly, the present invention provides a leakage current protection device, which includes a shell and a core assembly disposed within the shell, the core assembly including: a leakage current protection assembly coupled to power supply lines, the leakage current protection assembly including an execution unit and an operation unit configured to control the execution unit, wherein the execution unit is operable to connect and disconnect an electrical connection between the input end and the output end of the power supply lines; and a auxiliary function assembly, coupled to the leakage current protection assembly, configured to perform at least one load-end function.

The invention may be implemented in one or more of the following embodiments.

In some embodiments, the at least one load-end function includes at least a power conversion function and/or an electromagnetic compatibility (EMC) filter function.

In some embodiments, an output end of the leakage current protection assembly is coupled to an input end of the auxiliary function assembly.

In some embodiments, an input end of the leakage current protection assembly is coupled to one of: insertion plates, wiring terminals, and the power supply lines.

In some embodiments, an output end of the auxiliary function assembly is coupled to one of: insertion plates, wiring terminals, and the power supply lines.

In some embodiments, an output end of the leakage current protection assembly and an output end of the auxiliary function assembly are coupled to the power supply lines, and wherein the power supply lines include a first pair of power supply wires coupled to the output of the leakage current protection assembly and a second pair of power supply wires coupled to the output of the auxiliary function assembly.

In some embodiments, the first pair of power supply wires are different from the second pair of power supply wires.

In some embodiments, the leakage current protection device further includes a wire crimping assembly configured to affix the power supply lines in the shell.

In some embodiments, the leakage current protection assembly further includes a control circuit board, wherein the execution unit and the operation unit are coupled to the control circuit board.

In some embodiments, the operation unit includes a reset assembly and a trip assembly, configured to connect and disconnect the electrical connection between the input end and the output end of the power supply lines.

In some embodiments, the operation unit further includes a test assembly.

In some embodiments, the auxiliary function assembly includes an auxiliary control circuit board, functional components coupled to the auxiliary control circuit board, and a support frame configured to support the auxiliary control circuit board, wherein the auxiliary control circuit board is spaced apart from the control circuit board by the support frame.

In some embodiments, the auxiliary function assembly and the leakage current protection assembly share the control circuit board.

By integrating the auxiliary function assembly into the leakage current protection device, the leakage current protection device according to embodiments of the present invention can perform at least a part of the load-end functions, such as, without limitation, power conversion function and/or electromagnetic compatibility filter function. The device is reliable and versatile, and suitable for various electrical appliances. Moreover, the device has a simple structure and is easy to implement, and can be used in a wide variety of applications.

### BRIEF DESCRIPTION OF DRAWINGS

Other features and advantages of the present invention may be understood from the embodiments described below with reference to the drawings.

FIG. 1 is an exterior view of a leakage current protection device according to embodiments of the present invention.

FIG. 2 is an exploded view of the leakage current protection device of FIG. 1.

FIG. 3 is an exploded view of the leakage current protection assembly of the leakage current protection device of FIG. 2.

FIG. 4 is an exploded view of the auxiliary function assembly of the leakage current protection device of FIG. 2.

FIG. 5 is an exploded view of a leakage current protection device according to another embodiment of the present invention.

FIG. 6 is an exploded view of a leakage current protection device according to another embodiment of the present invention.

FIG. 7 is an exploded view of a leakage current protection device according to another embodiment of the present invention.

FIG. 8 is a circuit diagram of a leakage current protection device according to an embodiment of the present invention.

### DETAILED DESCRIPTION OF THE INVENTION

Preferred embodiments of the present and their applications are described below. It should be understood that these descriptions describe embodiments of the present invention but do not limit the scope of the invention. When describing the various components, directional terms such as “up,” “down,” “top,” “bottom” etc. are not absolute but are relative. These terms may correspond to the views in the various illustrations, and can change when the views or the relative positions of the components change.

In the descriptions below, terms such as “comprising”, “including”, “containing”, “having”, etc. are intended to be open-ended and do not exclude elements, step or components not specifically listed. The term “consisting of” excludes elements, step or components not specifically listed. The term “consisting essentially of” means including the specifically listed elements, step or components and other elements, step or components that do not materially affect the basic and novel characteristics of the claimed invention. The term “comprising” covers “consisting of” and “consisting essentially of”.

In this disclosure, unless otherwise indicated, terms such as “mount”, “connect”, “couple”, “link” etc. should be understood broadly; for example, they may be fixed connections, or removable or detachable connections, or integrally connected for integrally formed; they may be directly connected, or indirectly connected via intermediate parts, and may refer to internal connection of two components or mutual interactions of two components. Those skilled in the relevant art can readily understand the meaning of these terms as used in this disclosure based on the specific description and context.

To meet the increased need for leakage current protection devices that are compatible with different types of appliances and have increased functionalities, embodiments of the present invention provide an leakage current protection device with auxiliary functions, which can perform part of the functions of the electrical load (appliance) connected to the leakage current protection device. In this disclosure, an electrical power plug is used as an example of the leakage current protection device, but the invention is not limited to such examples, and can include other types of leakage current protection device, such as power receptacles.

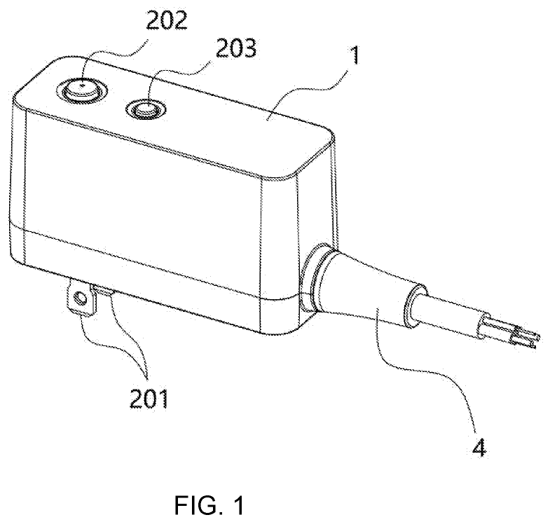

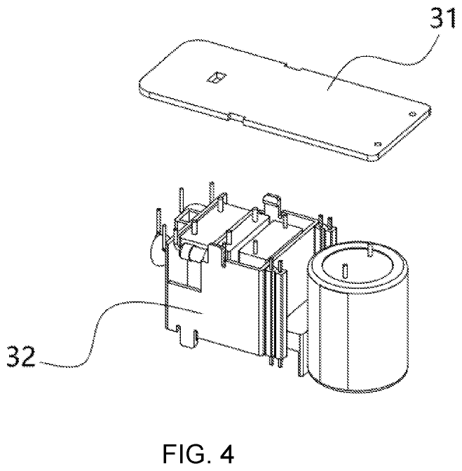

FIGS. 1-4 illustrate a leakage current protection device according to an embodiment of the present invention. In this embodiment, the leakage current protection device includes a shell (body) 1 and a core assembly disposed inside the shell, and a power cord 42 that is connected to the shell and extends from the shell. The shell 1 includes an upper cover 11 and a base 12, affixed to each other using suitable fasteners such as screws 6. The core assembly includes a leakage current protection assembly 2 and an auxiliary function assembly 3. The leakage current protection assembly 2 includes an execution unit and an operation unit that controls the execution unit, so that the execution unit is operated to open and close the electrical connection to the load. The auxiliary function assembly 3 is coupled to the leakage current protection assembly 2, and implements one or more functions related to the electrical load (referred to as the load-end functions).

In embodiments of the present invention, the load-end functions include at least a power conversion (AC/DC conversion) function and/or an electromagnetic compatibility (EMC) filter function. The auxiliary function assembly 3 may combine the power conversion function and EMC filter function, or implement one of the two.

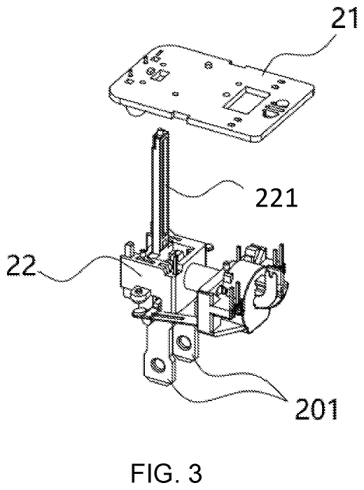

In the embodiment shown in FIG. 3, the leakage current protection assembly 2 includes a control circuit board 21, and an execution unit 22 and an operation unit coupled to the control circuit board 21. The execution unit 22, also referred to as the switch unit, may be implemented by any suitable structure that can open and close the electrical path between the input end and the output end of the leakage current protection assembly 2, including, without limitation, resilient arms having moving contact terminals that can make or break contact with stationary contact terminals. Such switch structures are known in the art, and detailed descriptions are omitted here.

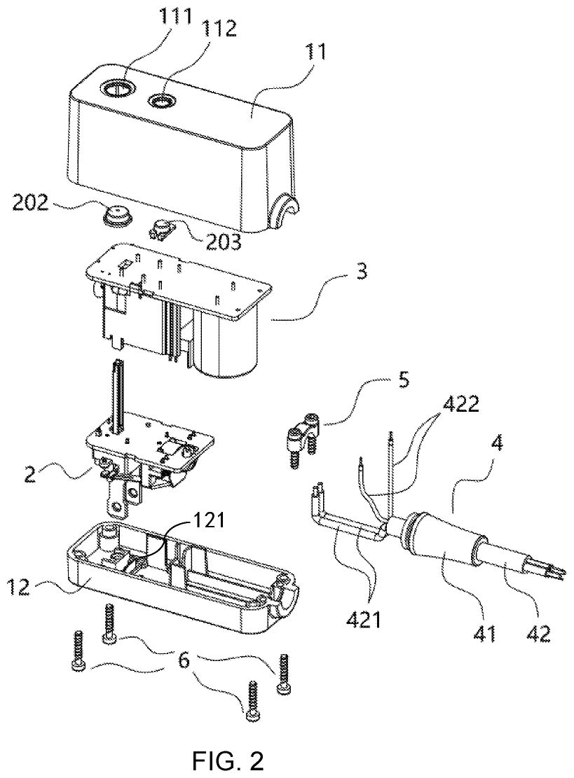

In the illustrated embodiments, the operation unit includes a reset assembly and a trip assembly, which accomplish the electrical connection and disconnection between the input and output ends of the leakage current protection assembly 2. As shown in FIGS. 2 and 3, the reset assembly includes a reset shaft 221 that extends from the execution unit 22, and a reset button 202 that cooperates with the reset shaft 221 and protrudes out of the upper cover 11. Correspondingly, the upper cover 11 has a reset button guide hole 111 that allows the reset button 202 to protrude out, allowing it to be manually operated by a user. In some embodiments, the operation unit further includes a test assembly. As shown in FIG. 2, the test assembly includes a test button 203, and correspondingly, the upper cover 11 has a reset button guiding hole 112 that allows the test button 203 to protrude out, allowing it to be manually operated by a user. When the reset assembly is operated, e.g., when the reset button 202 is pushed down, the reset assembly and the trip assembly cooperate with each other to cause the execution unit 22 to be in a closed state, so that power is output to the load end. When the test assembly is operated, e.g., when the test button 203 is pushed down, the test assembly generates a simulated leakage current, and in response thereto, the leakage current protection assembly 2 is switched to the open state to disconnect the electrical connection to the load end. The leakage current protection assembly 2 also detects leakage current in the electrical path between the input and the output ends, and if the leakage current reaches a predetermined condition, the leakage current protection assembly 2 disconnects the electrical connection to the load end, preventing potential electrical shock to the user. It should be understood that the reset assembly and trip assembly may be implemented by any suitable structures that respectively perform reset and trip functions, and the test assembly may be implemented by any suitable structure that performs test functions. Many such structures are known in the art, and detailed descriptions are omitted here.

In the embodiment shown in FIGS. 2 and 3, the auxiliary function assembly 3 includes an auxiliary control circuit board 31 and functional components coupled to the auxiliary control circuit board 31. The functional components may include various electrical elements that implement the functions such as AC/DC conversion and EMC filtering. The electrical elements may include, without limitation, capacitors, inductors, resistors, etc.

In the illustrated embodiment, the auxiliary control circuit board 31 is supported by a support frame 32 and spaced apart from the control circuit board 21. The above-mentioned electronic elements may be accommodated in the support frame 32, or they may be positioned and supported by the support frame 32. This way, the reset shaft 221 passes through an opening provided on the control circuit board 21 and the auxiliary control circuit board 31, and extends to the vicinity of the reset button guide hole 111 of the upper cover 11 to be connected with the reset button 202, thereby facilitating the operation of the reset assembly to achieve the closed (connected) state of the leakage current protection assembly 2.

In some embodiment, the auxiliary function assembly 3 and leakage current protection assembly 2 may share a common control circuit board.

Regardless of the spatial arrangement, the output end of the leakage current protection assembly 2 is coupled to the input end of the auxiliary function assembly 3, to supply power to the auxiliary function assembly 3. Depending on practical needs, the input end of the leakage current protection assembly 2 may be coupled to any one of: insertion plates, wiring terminals, power supply wires, etc.; the output end of the auxiliary function assembly 3 may be coupled to any one of wiring terminals, power supply wires, etc.

In the embodiment of FIGS. 1-4, the input end of the leakage current protection assembly 2 is coupled to a pair of insertion plates 201. Correspondingly, the base 12 is provided with a pair of insertion plate holes 121 that allow one ends of the insertion plates 201 to pass through and extend out of the shell, so that they may be inserted into a power receptacle to receive power. The other ends of the insertion plates 201 are coupled to the input end of the leakage current protection assembly 2. The output end of the leakage current protection assembly 2 and the output end of the auxiliary function assembly 3 are coupled to the power cord 42. The power cord 42 includes a first pair of power supply wires 421 coupled to the output of the leakage current protection assembly 2, and a second pair of power supply wires 422 coupled to the output of the auxiliary function assembly 3. In the embodiment shown in FIG. 2, the power cord 42 and a cable strain relief 41 together form the output cable assembly 4, where the cable strain relief 41 is partially inserted in the shell 1. Further, the first pair of power supply wires 421 are different from the second pair of power supply wires 422, in that first pair of power supply wires 421 are thicker and used to transmit the AC power which has a higher current, and the second pair of power supply wires 422 are thinner and used to transmit the DC power which has a lower current.

In some embodiments, the leakage current protection device further includes a wire crimping assembly. As shown in FIGS. 2 and 5 or 6, the wire crimping assembly 5 engages one end of the output cable assembly 4, and affixes the power cord 42 to the shell 1.

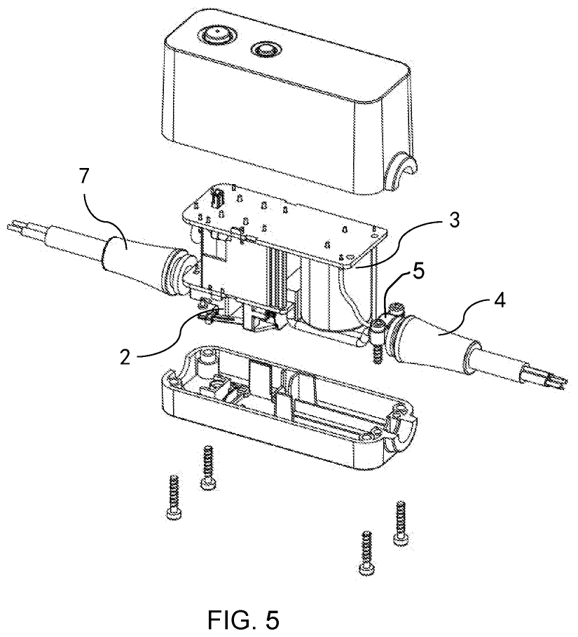

FIGS. 5 to 7 respectively illustrate several leakage current protection devices according to alternative embodiments of the present invention.

In the embodiment of FIG. 5, the output end of the leakage current protection assembly 2 is coupled to the input end of the auxiliary function assembly 3, and both the output end of the 2 and the output end of the auxiliary function assembly 3 are coupled to the power supply lines or the output cable assembly 4. One difference between the embodiment of FIG. 5 and that of FIGS. 1-4 is that, in FIG. 5, the input end of the leakage current protection assembly 2 is coupled to external power supply lines or to an input cable assembly 7 that contains power supply lines, and no insertion plates 201 are required. This device may be used in different application scenarios.

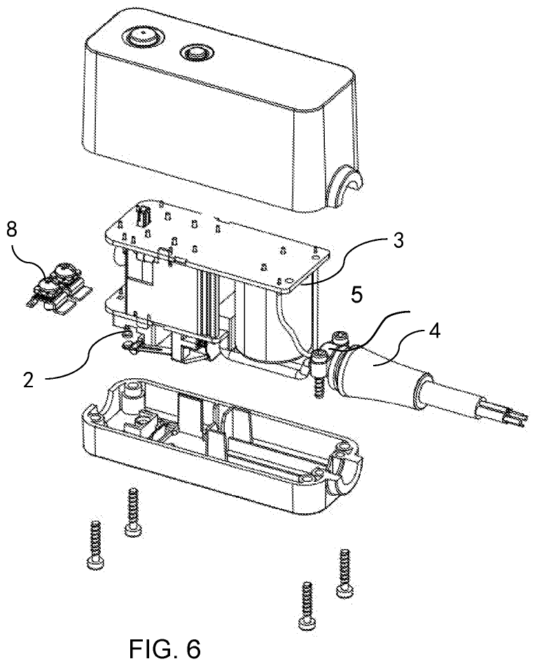

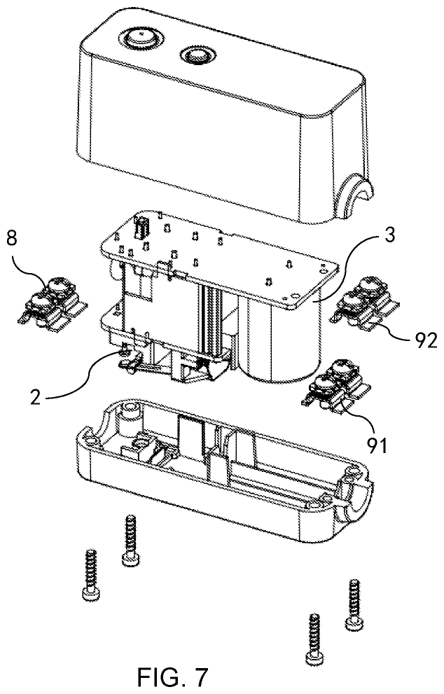

In the embodiment of FIG. 6, both the output end of the leakage current protection assembly 2 and the output end of the auxiliary function assembly 3 are coupled to the output cable assembly 4 (like FIGS. 1-4), but the input end of the leakage current protection assembly 2 is coupled to wiring terminals 8, rather than having insertion plates 201 (unlike FIGS. 1-4). In the embodiment of FIG. 7, the input end of the leakage current protection assembly 2 is coupled to wiring terminals 8 (like FIG. 6), but the output end of the leakage current protection assembly 2 and the output end of the auxiliary function assembly 3 are respectively coupled to first wiring terminals 92 and second wiring terminals 93, rather than to an output cable assembly 4 (unlike FIG. 6). It can be seen that by providing different coupling options for the input end and output end of the leakage current protection device, the device may be adapted for use in a wide range of application scenarios and for different electrical appliances, increasing its versatility.

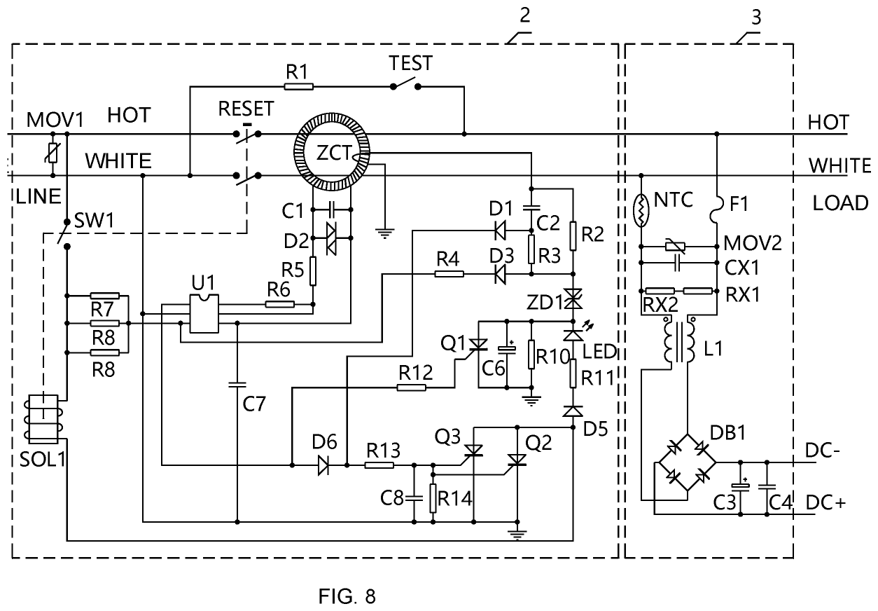

The operation principles of the leakage current protection device according to an embodiment of the present invention is described with reference to FIG. 8.

In FIG. 8, the leakage current protection assembly 2 and auxiliary function assembly 3 are indicated by dashed line boxes.

When the leakage current protection assembly 2 is functioning normally, if a leakage current is present on the hot (HOT) or neutral (WHITE) lines of the power supply lines, a transformer or detection coil ZCT collects a leakage current signal and provides it to a processor U1 for processing. If the leakage current exceeds a preset threshold, the processor U1 triggers transistors Q2 and Q3 to become conductive. As a result, a sufficiently large current flows through the trip coil (solenoid) SOL, which generates a magnetic force to drive the trip assembly to move, to disconnect the electrical connection between the input end and output end of the leakage current protection device, thereby achieving leakage current protection. When no leakage current is present, when the user presses the reset button RESET, the leakage current protection assembly 2 is reset and connects the electrical power between the input end and the output end.

In the auxiliary function assembly 3, the AC current from the hot (HOT) and neutral (WHITE) power supply lines is filtered by the EMC functional module formed of a varistor MOV2, a capacitor CX1, and an inductor L1, rectified by a rectifier bridge DB1 into a DC current, and then output via a capacitor C3 (e.g. an electrolytic capacitor) so the voltage of the DC output is further smoothed. This rectifying circuit can output stable DC voltage. Further, this circuit reduces the transmission of EMC disturbance signals, thereby reducing the interference experienced by the rectifying circuit, reducing the interference experienced by the leakage current protection circuit, increasing the accuracy of the output DC voltage with reduced error, and improving the performance of the leakage current protection device.

It should be understood that the embodiments shown in the drawings only illustrate the main implementing units and components of the leakage current protection device. The shapes, sizes and spatial arrangements of the various components only illustrate the embodiments and are not limiting. Other shapes, sizes and spatial arrangements may be used without departing from the spirit of the invention.

It will be apparent to those skilled in the art that various modification and variations can be made in the embodiments of the present invention without departing from the spirit or scope of the invention. Thus, it is intended that the present invention cover modifications and variations that come within the scope of the appended claims and their equivalents.

1. A leakage current protection device, comprising:
a shell; and
a core assembly disposed within the shell, the core assembly including:
power supply lines having an input end and an output end;
a leakage current protection assembly coupled to power supply lines, the leakage current protection assembly including an execution unit and an operation unit configured to control the execution unit, wherein the execution unit is operable to connect and disconnect an electrical connection between the input end and the output end of the power supply lines; and
a auxiliary function assembly, coupled to the leakage current protection assembly, configured to perform at least one load-end function.

2. The leakage current protection device of claim 1, wherein the at least one load-end function includes at least a power conversion function and/or an electromagnetic compatibility (EMC) filter function.

3. The leakage current protection device of claim 1, wherein an output end of the leakage current protection assembly is coupled to an input end of the auxiliary function assembly.

4. The leakage current protection device of claim 1, wherein an input end of the leakage current protection assembly is coupled to one of: insertion plates, wiring terminals, and the power supply lines.

5. The leakage current protection device of claim 1, wherein an output end of the auxiliary function assembly is coupled to one of: insertion plates, wiring terminals, and the power supply lines.

6. The leakage current protection device of claim 1, wherein an output end of the leakage current protection assembly and an output end of the auxiliary function assembly are coupled to the power supply lines, and wherein the power supply lines include a first pair of power supply wires coupled to the output of the leakage current protection assembly and a second pair of power supply wires coupled to the output of the auxiliary function assembly.

7. The leakage current protection device of claim 6, wherein the first pair of power supply wires are different from the second pair of power supply wires.

8. The leakage current protection device of claim 6, further comprising a wire crimping assembly configured to affix the power supply lines in the shell.

9. The leakage current protection device of claim 1, wherein the leakage current protection assembly further includes a control circuit board, and wherein the execution unit and the operation unit are coupled to the control circuit board.

10. The leakage current protection device of claim 9, wherein the operation unit includes a reset assembly and a trip assembly, configured to connect and disconnect the electrical connection between the input end and the output end of the power supply lines.

11. The leakage current protection device of claim 10, wherein the operation unit further includes a test assembly.

12. The leakage current protection device of claim 9, wherein the auxiliary function assembly includes an auxiliary control circuit board, functional components coupled to the auxiliary control circuit board, and a support frame configured to support the auxiliary control circuit board, wherein the auxiliary control circuit board is spaced apart from the control circuit board by the support frame.

13. The leakage current protection device of claim 9, wherein the auxiliary function assembly and the leakage current protection assembly share the control circuit board.
